(19) United States
(12) Patent Application Publication
(10) Pub. No.: US 2007/0064998 A1
(43) Pub. Date: Mar. 22, 2007

(54) Pattern inspection apparatus, pattern inspection method, and inspection sample

(75) Inventors: Takuo Umeda, Kanagawa (JP); Kenichi Matsumura, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Advanced Mask Inspection Technology Inc., Kawasaki-shi (JP)

(21) Appl. No.: 11/338,708

(22) Filed: Jan. 25, 2006

(30) Foreign Application Priority Data
Sep. 22, 2005 (JP) 2005-276585

(51) Int. Cl. G06K 9/00

(52) U.S. Cl. 382/149

(57) ABSTRACT

A pattern inspection apparatus for inspecting a pattern of a plurality of dies formed on an inspection sample, includes: a stream image memory device, which stores a stream image of the inspection sample; and a DD comparison unit which performs DD comparison, mutually comparing the pattern of each of the dies in the stream image.

### CROSS-REFERENCE TO RELATED APPLICATION

This application is based upon and claims the benefit of priority from prior Japanese Patent Application No. 2005-276585 filed on Sep. 22, 2005 in Japan, the entire contents of which are incorporated herein by reference.

### BACKGROUND OF THE INVENTION

1. Field of the Invention

The present invention relates to a pattern inspection apparatus of an inspection sample, a pattern inspection method, and an inspection sample inspected, and, more particularly, relates to a pattern inspection apparatus, a pattern inspection method, and an inspection sample inspected, of a reticle (mask) for use in semiconductor elements, liquid crystal display panels, and manufacturing thereof.

2. Description of the Related Art

In a manufacturing process of large scale integrated circuits (LSI), an optical reduction exposure device (stepper) for circuit pattern transfer uses a reticle having a circuit pattern magnified 4 to 5 times as an original master. A request for integrity, that is, pattern precision, no defects, or the like has been extremely increasing year by year. In recent years, a pattern transfer is carried out in the vicinity of a critical resolution of the stepper with super miniaturization and high integration, and a high precision reticle becomes a key factor in device manufacturing. Among them, performance improvement of a pattern inspection apparatus for detecting a defect of a super-fine pattern is essential for the improvement in a short-term development and a manufacturing yield of an advanced semiconductor device. In a pattern inspection of a high precision reticle, a reference image resembling an optical image depicted in a reticle is made from reticle design data (for example, depiction data), and the optical image is compared with the reference image to detect defects in a reticle pattern (die-database inspection (DB inspection)). In the case where this high precision DB inspection based on CAD data is applied over the entire reticle, there arises a problem of increase in processing load and processing time for advance preparation of vast amounts of CAD data. Further, defects in a reticle pattern are detected by comparing optical images of the reticle (die-die inspection (DD inspection)) (refer to Japanese Patent Application Publication No. 1-40489). In the DD inspection, there arises a problem in that defects common to dies due to defects generated in depicting into a reticle or the like or in making depiction data cannot be detected. As described, with the increasing amount of CAD data involving miniaturization of pattern, there arise problems in that advance processing load and inspection processing time increase in the DB inspection, and inspection sensitivity decreases in the DD inspection.

### BRIEF SUMMARY OF THE INVENTION

An object of the present invention is to reduce inspection processing time of a pattern in an inspection sample and, at the same time, to ensure high inspection sensitivity.

Another object of the present invention is to perform complex inspection combining both advantages of high precision DB inspection and light load DD inspection.

Still another object of the present invention is to obtain a pattern inspection apparatus and a pattern inspection method capable of obtaining a fine pattern, or to obtain an inspection sample having a fine pattern.

An embodiment according to the present invention provides a pattern inspection apparatus for inspecting a pattern of a plurality of dies formed in an inspection sample, including: a stream image memory device which stores a stream image of the inspection sample; and a DD comparison unit which performs DD comparison, mutually comparing the pattern of each of the dies in the stream image.

An embodiment according to another aspect of the present invention provides a pattern inspection method for inspecting a pattern of a plurality of dies formed in an inspection sample, including: storing a stream image of the inspection sample in a memory device; and performing DD comparison processing which performs DD comparison, mutually comparing each of the dies.

An embodiment according to another aspect of the present invention provides an inspection sample having patterns of a plurality of dies, wherein a stream image of the inspection sample is stored and DD comparison is performed, mutually comparing each of the dies.

### BRIEF DESCRIPTION OF THE FIGURES OF THE DRAWING

FIG. 1 is an explanation view showing a pattern inspection apparatus which stores a stream image in a stream image memory device and performs DB comparison and DD comparison;

FIG. 2(A) and FIG. 2(B) are an explanation view showing a pattern inspection apparatus which stores stream images in two stream image memory devices and performs DB comparison and DD comparison;

FIG. 3 is an explanation view showing a pattern inspection apparatus which defines a central die as a reference die, stores stream images in three stream image memory devices, and performs DB comparison and DD comparison;

FIG. 4 is an explanation view showing a schematic configuration of a pattern inspection apparatus;

FIG. 5 is an explanation view showing a schematic configuration of a comparison processing unit;

FIG. 6 is an explanation view showing scanning of a reticle;

FIG. 7 is an explanation view showing a comparison method of a first embodiment;

FIG. 8 is an explanation view showing a comparison method of a second embodiment;

FIG. 9(A) and FIG. 9(B) are an explanation view showing a comparison method of a third embodiment; and

FIG. 10(A) to FIG. 10(F) are explanation views showing comparison methods of another embodiment.

### DETAILED DESCRIPTION OF THE INVENTION

A pattern inspection apparatus, a pattern inspection method, and an inspection sample according to embodiments of the present invention will be described below.

(Pattern Inspection Apparatus)

A pattern inspection apparatus is to inspect whether or not a pattern formed in an inspection sample such as a reticle is formed in a predetermined shape. The pattern inspection apparatus includes an optical image acquisition unit and a data processing unit, for example. The optical image acquisition unit is to acquire an optical image by reading a pattern depicted in the inspection sample. The data processing unit is to perform control of the pattern inspection apparatus such as the optical image acquisition unit, to perform data processing which obtains a reference image from design data of a reticle, or to perform various kinds of data processing such as analysis of defect data of the pattern. Reticle will be described below as the inspection sample; however, the inspection sample may be any sample provided that a pattern is formed, such as a mask or wafer.

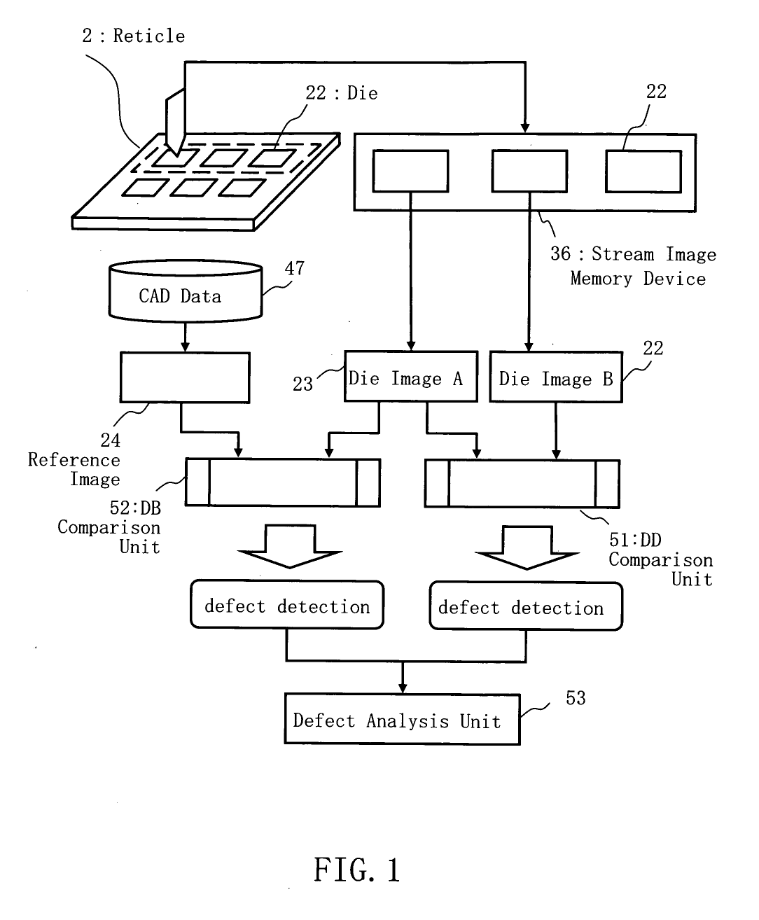

FIG. 1 shows a configuration example of a pattern inspection apparatus. The pattern inspection apparatus performs a pattern inspection of a multiple die reticle 2 in which a plurality of dies 22 are depicted. The multiple die reticle 2 has M dies in the Y direction and N dies in the X direction, which are two dimensionally disposed in the reticle. X and Y used here is an expression which denotes only two dimensions and does not imply a specific direction. The pattern inspection apparatus includes a stream image memory device 36 which stores a stream image of the reticle, a DD comparison unit 51 which compares images (a die image A and a die image B) of the dies 22 of optical images in the reticle 2, a DB comparison unit 52 which compares the optical images in the reticle with a reference image obtained from CAD data (for example, depiction data) in the reticle, and a defect analysis unit 53 which analyzes defects detected by the DD comparison unit 51 and the DB comparison unit 52.

The stream image is an optical image obtained by scanning a pattern of the reticle in a stream unit in one direction (X direction) and has a plurality of die images. The stream unit is a range acquired from a first image acquisition position to a last image acquisition position by scanning the pattern in the reticle 2 in the X direction. The stream image or the stream unit used here includes sub-stream images or sub-stream units in which the stream image or the stream unit is divided into a plurality of sub-stream images or sub-stream units. For example, it is assumed that a width of the stream image is 2048 pixels. In the case where a width of the sub-stream image is ¼ of the width of the stream image, the width of the sub-stream image becomes approximately 512 pixels. The stream image generally represents a part of the each die 22.

When the pattern inspection apparatus of FIG. 1 is used, the plurality of dies 22 in the stream image can be mutually performed by DD comparison because the stream image is stored in the stream image memory device 36. At the same time, the dies 22 in the stream image can be performed by DB comparison, being compared with a reference image 24. More particularly, the die performed by DB comparison, defined as a reference die, is performed by DD comparison, being compared with another die. This comparison method can perform complex inspection combining both advantages of high precision DB comparison and light load DD comparison. This comparison method can reduce inspection processing time of the pattern and, at the same time, can ensure high inspection sensitivity. Complex inspection combining both advantages of high precision DB comparison and light load DD comparison can be performed. In addition, the reference die is a die which is defined as a reference when the dies are compared. The reference die is a die performed by the DB comparison, for example.

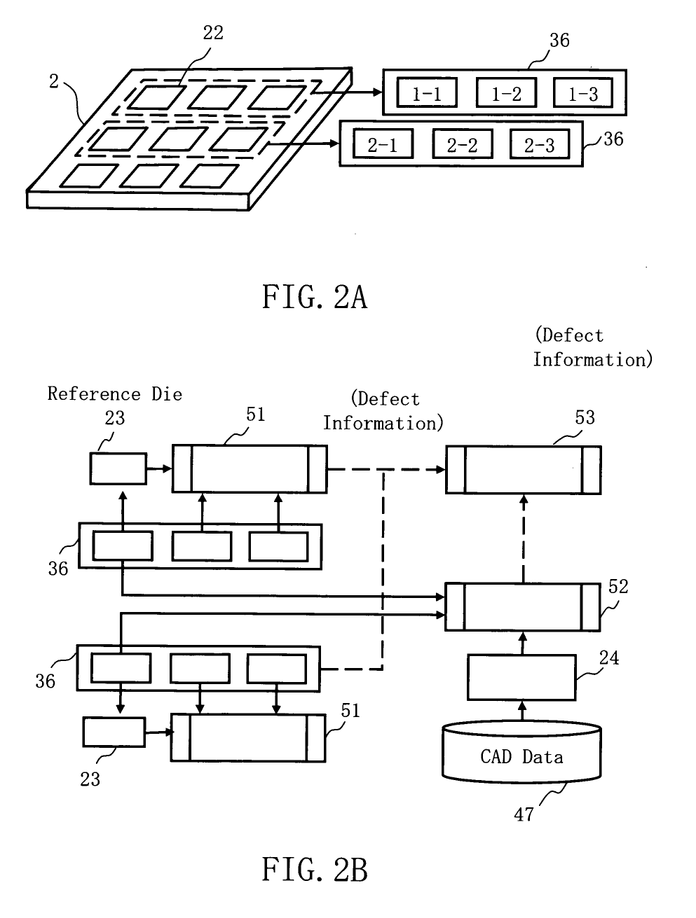

FIG. 2(A) and FIG. 2(B) are another configuration example of a pattern inspection apparatus. The pattern inspection apparatus of FIG. 2(A) and FIG. 2(B) have a configuration similar to the pattern inspection apparatus of FIG. 1 but has a feature in that it includes a plurality of stream image memory devices 36 and 36 which store a plurality of stream images. An example of the pattern inspection apparatus of FIG. 2(A) and FIG. 2(B) can store two directional stream images, for example, one is the X direction and the other is its reverse direction. This configuration allows performing DD comparison processing, parallelly comparing dies 22 of the two stream images. A specific die in each stream image is performed by DB comparison processing, being compared with a reference image obtained from CAD design data, and a reference die 23 of the each stream image can be obtained. The reference die 23 and the other dies 22 are performed by the DD comparison processing for every stream image. As for defect information obtained by the comparison processing, a pattern defect is analyzed by the defect analysis unit 53.

Assuming that the reference die 23 is a die placed at the left end (in FIG. 2(A) and FIG. 2(B)), DD comparison processing and DB comparison processing can be continuously performed. In this way, accuracy of the pattern inspection can be enhanced by defining the reference die 23 as a die depicted by substantially the same condition. In addition to that, once scanning is completed in one direction of the reticle, scanning in the reverse direction is done and images in the stream unit are stored by the reciprocating processing, and therefore, processing time of the pattern inspection of the entire reticle can be shortened.

In the pattern inspection apparatus of FIG. 2(A) and FIG. 2(B), the DD comparison unit 51 is provided for each stream image, the DB comparison unit 52 is commonly provided for two stream images, and the defect analysis unit 53 is also commonly provided. In this regard, however, the number of the DD comparison unit 51, DB comparison unit 52, and defect analysis unit 53 can be arbitrarily set according to the amount of data processing, processing speed, and the like. In addition, a device which stores the stream images of the pattern inspection apparatus is, for example, a buffer memory that temporarily stores the stream images. The memory device of FIG. 2(A) and FIG. 2(B) includes two stream image memory devices 36 and 36 which store two stream images, however, more stream image memory devices 36 may be provided. For example, in the case where the pattern inspection apparatus stores 12 stream images and each stream unit is composed of 4 sub-stream units, 48 stream image memory devices 36 for sub-stream unit are provided.

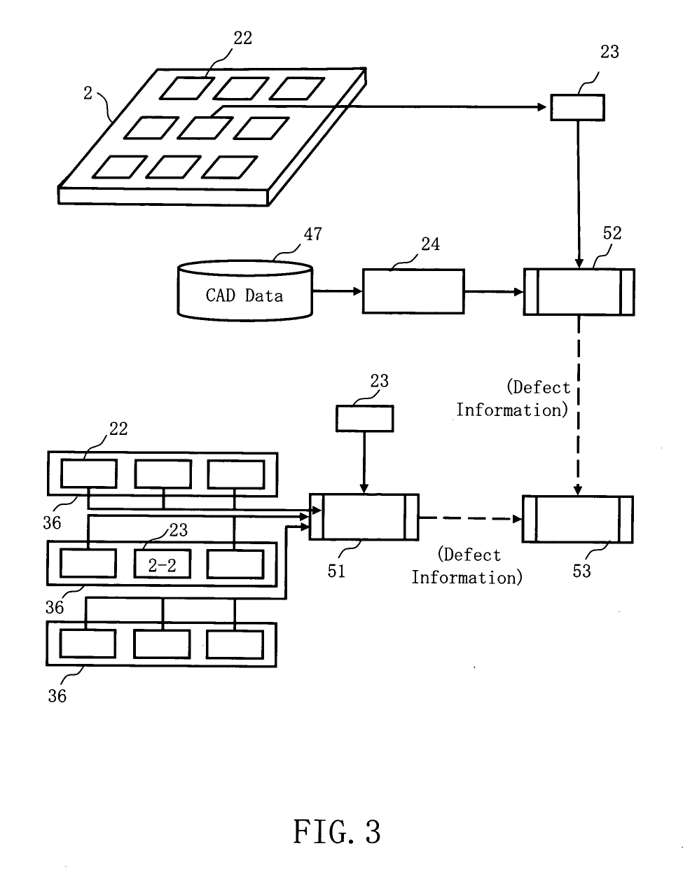

FIG. 3 shows another further configuration example of a pattern inspection apparatus. The pattern inspection apparatus of FIG. 3 has a configuration similar to the pattern inspection apparatuses of FIG. 1 and FIG. 2(A) and FIG. 2(B) but has a feature in that a specific die in the entire reticle, for example, a die adjacent to the center, is defined as the reference die 23. Since the die adjacent to the center is placed near the remaining dies, it can be deemed that an optical image of the die adjacent to the center is similar to optical images of the remaining dies. In an example of the pattern inspection apparatus of FIG. 3, the apparatus includes three stream image memory devices 36, one DB comparison unit 52, one DD comparison unit 51, and one defect analysis unit 53.

In the pattern inspection apparatus of FIG. 3, the center die is defined as the reference die 23 and is performed by DB comparison processing, being compared with the reference image 24. Dies 22 of the three stream images are performed by the DD comparison processing, being compared with the reference die 23. These DD comparisons can be parallelly processed by a plurality of DD comparison units 51. Defect information obtained by performing DD comparison processing on each stream image is analyzed by the defect analysis unit 53 on the pattern defect. These three stream images are obtained by the following way. First, the reticle is scanned in one direction to store optical images of the stream unit in the stream image memory device 36, then scanned in the reverse direction to store optical images of the stream unit in different stream image memory device 36, and then scanned in one direction to store optical images of the stream unit in further different stream image memory device 36. In this manner, a plurality of stream images can be efficiently stored by such reciprocating movement.

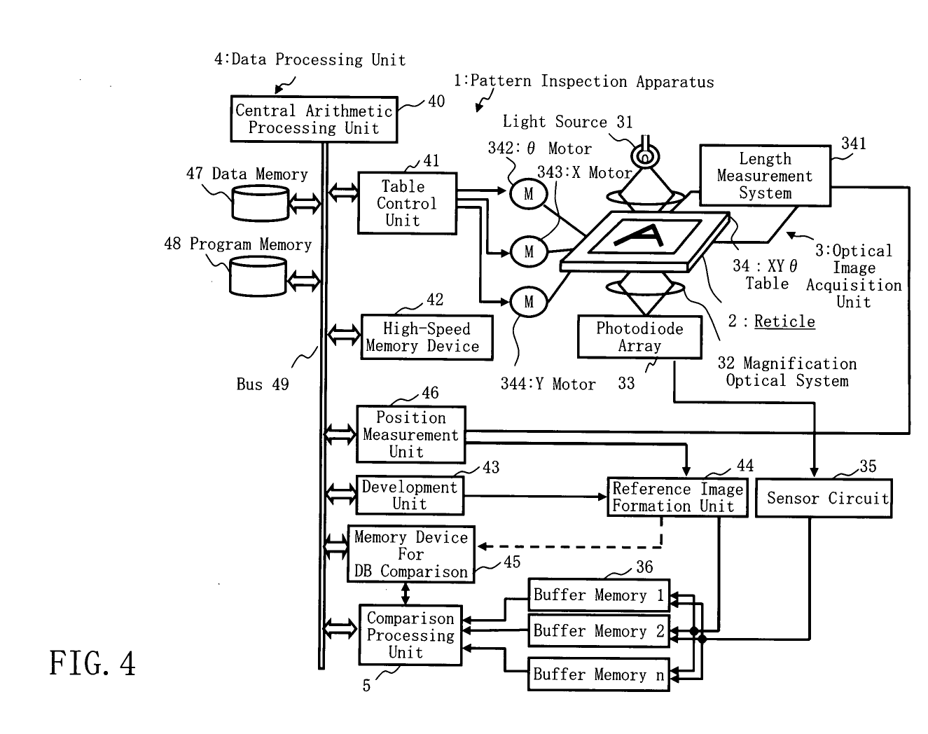

FIG. 4 is a view showing the entire schematic configuration of a pattern inspection apparatus. A pattern inspection apparatus 1 mainly includes an optical image acquisition unit 3 and a data processing unit 4. The optical image acquisition unit 3 mainly includes a light source 31, a XYθ table 34 which mounts the reticle 2, a θ motor 342, an X motor 343, a Y motor 344, a laser measurement system 341, a magnification optical system 32, a photodiode array 33, a sensor circuit 35, and a buffer memory 36.

The data processing unit 4 mainly includes a central arithmetic processing unit 40, bus 49, a table control unit 41 which controls the XYθ table 34, a data memory 47, a program memory 48, a high speed memory device 42, a development unit 43, a reference image formation unit 44, a comparison processing unit 5, a memory device for DB comparison 45, and a position measurement unit 46. The development unit 43 and the reference image formation unit 44 are connected to external memory devices such as the high-speed memory device 42, data memory 47, and program memory 48 via the bus 49 of the central arithmetic processing unit 40. As the external memory devices, a magnetic disk device, an optical disk device, magneto-optic disk device, magnetic drum device, magnetic tape device, and the like can be used. The data memory 47 stores design pattern data, for example. Design pattern data is stored such that the entire inspection area of the reticle is divided into strip-shaped areas. The reference image formation unit 44 accepts an image pattern developed from the development unit 43 and accepts from image position information from the position measurement unit and forms the reference image. The reference image formation unit 44 outputs the reference image to the memory device for DB comparison 45 and the buffer memory 36.

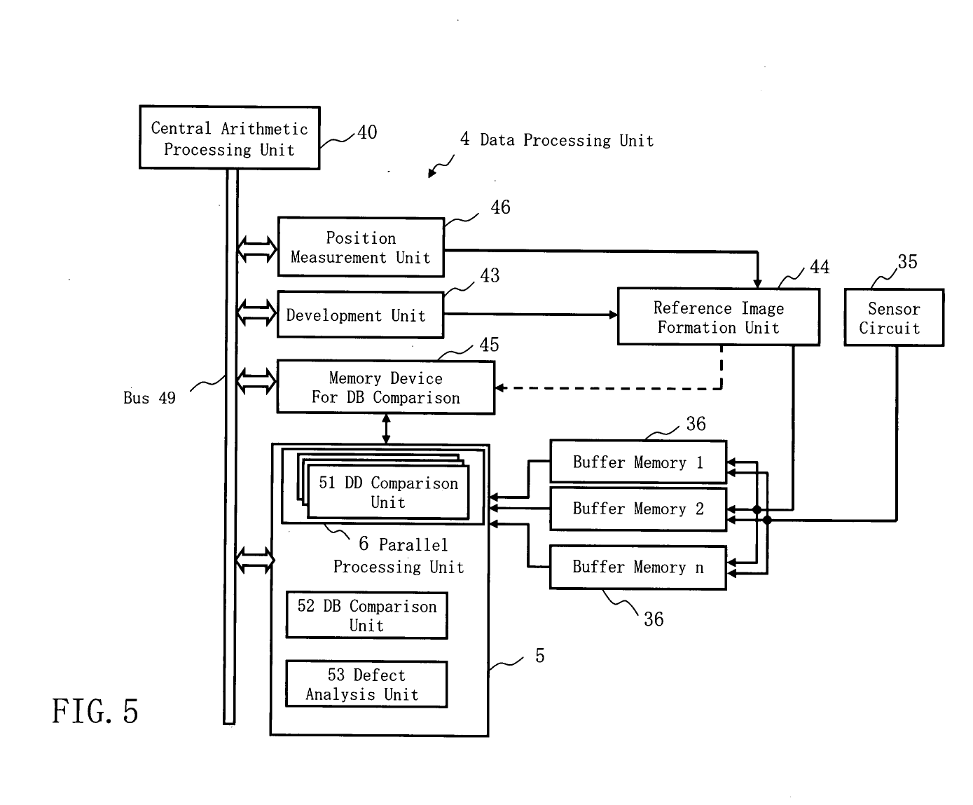

FIG. 5 is a view showing a configuration of the comparison processing unit 5. The comparison processing unit 5 mainly includes the DD comparison unit 51, the DB comparison unit 52, and the defect analysis unit 53. The comparison processing unit 5 has a parallel processing function, and a plurality of the same functions, and can perform parallel processing. A parallel processing unit 6 is arranged with at least a plurality of the DD comparison units 51. The parallel processing unit 6 may be arranged with a plurality of the DB comparison units 52 and the defect analysis units 53, if necessary. Further, the comparison processing unit 5 may control the memory device for DB comparison 45. The comparison processing unit 5 accepts the reference image from the memory device for DB comparison 45 and accepts the optical images from the buffer memories 36. If necessary, the comparison processing unit 5 can also accept the reference image. The comparison processing unit 5 performs DB comparison which compares the accepted reference image with the optical images, or performs DD comparison, and analyzes image defects from the comparison result.

The pattern inspection apparatus 1 mainly includes an input unit (not shown in the figure) which accepts inputs such as data or commands from users, an output unit (not shown in the figure) which outputs inspection results, the data memory 47 which stores design pattern data or the like, and the program memory 48 which stores inspection programs or the like. The input unit (not shown in the figure) is composed of a keyboard, mouse, light pen, floppy disk device, or the like. Further, the output unit (not shown in the figure) is composed of a display device, printer device, or the like. In addition, the pattern inspection apparatus 1, specifically the comparison processing unit 5, can be composed of an electronic circuit, program, PC, or combination of these components.

(Optical Image Acquisition Unit)

The optical image acquisition unit 3 acquires optical images in the reticle 2. The reticle 2 is placed on the XYθ table 34. The XYθ table 34 is a three axis (X-Y-θ) manipulator which is movable in the X direction and Y direction and rotatable in the θ direction by the table control unit 41 that accepted command from the central arithmetic processing unit 40. The drive control is performed by an X motor 343 in the X direction, by a Y motor 344 in the Y direction, and by a θ motor 342 in the θ direction. A known servomotor, stepping motor or the like can be used for the X motor 343, Y motor 344 and θ motor 342. A position coordinate of the XYθ table 34 is measured by, for example, a laser measurement system 341 and its output is sent to the position measurement unit 46. The position coordinate output from the measurement unit 46 is fed back to the table control unit 41.

The reticle 2 is automatically fed on the XYθ table 34 with an auto loader (not shown in the figure) and automatically ejected after the inspection completion. The light source 31 and its photo irradiation part are arranged above the XYθ table 34. Light from the light source 31 is irradiated to the reticle 2 via collective lens. A signal detection unit composed of the magnification optical system 32 and the photodiode array 33 is arranged below the reticle 2. Light transmitted through the reticle 2 is focused onto an acceptance surface of the photodiode array 33 via the magnification optical system 32. The magnification optical system 32 is automatically focused by a focusing device (not shown in the figure) such as a piezo element. The focusing device is controlled by an autofocus control circuit (not shown in the figure) connected to the central arithmetic processing unit 40. Focusing may be monitored by an observation scope separately provided. The photodiode array 33 as a photoelectric conversion unit is a line sensor or an area sensor arranged with a plurality of optical sensors. The photodiode array 33 detects a measurement signal corresponding to an image to be inspected of the reticle 2 by continuously moving the XYθ table 34 in the X axis direction.

The measurement signal is converted to digital data by the sensor circuit 35 and input to the buffer memory 36 as optical image data. A plurality of the buffer memories 36 may be provided. Output of the buffer memory 36 is sent to the comparison processing unit 5. The optical image data is, for example, unsigned data with 8 bits and expresses brightness of each pixel. This sort of the pattern inspection apparatus 1, generally, reads out these pattern data from the photodiode array 33 in synchronization with clock frequency of approximately 10 MHz to 30 MHz and treated as two dimensional image data performed by raster scanning after proper data rearrangement.

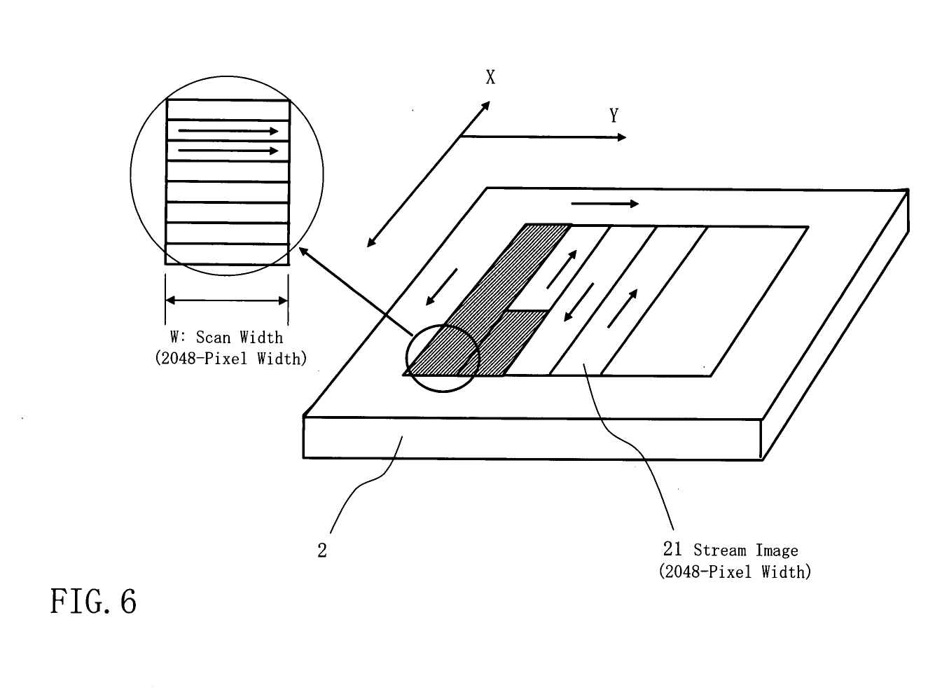

FIG. 6 is a view showing an example of acquisition procedure of the optical images. An area to be inspected of the reticle 2 is virtually divided into a plurality of strip-shaped stream images 21 with scanning width W toward the Y direction. The XYθ table 34 is moved in the X direction under the control of the table control unit 41 so that the divided stream images 21 are continuously scanned. Each stream image 21 is acquired by the photo diode array 33 with the movement. The photo diode array 33 continuously acquires the image with the scanning width W. The photodiode array 33 acquires a first stream image 21, and then, continuously acquires a second stream image 21 with the scanning width W in the reverse direction of the acquisition of the first stream image in the same manner. A third stream image 21 is acquired in the reverse direction of the acquisition of the second stream image 21, that is, in the direction of the acquisition of the first stream image 21. Wasted processing time can be shortened by continuously acquiring images in this way. Here, for example, scanning width W is 2048 pixels.

Measured pattern data of the stream image 21 output from the sensor circuit 35 is sent to the comparison processing unit 5, together with data which shows a position of the reticle 2 on the XYθ table 34 output from the position measurement unit 46. The optical image to be compared is delimited into an area of a proper pixel size, for example, delimited into an area of 512×512 pixels. In addition, the optical image uses transmitted light as described in the above, but reflected light, scattered light, polarized scattered light, polarization transmitted light may be used. In order to detect such image light, the image acquisition unit 3 has an acquisition mechanism which acquires such light images.

(Formation of Reference Image)

The reference image is an image formed in imitation of the optical image by performing various conversions from design data of the reticle 2. The reference image can be composed of, for example in FIG. 4, the development unit 43 and the reference image formation unit 44. The development unit 43 reads out design data of images in the reticle 2 from the data memory 47 by the central arithmetic processing unit 40 and converts to image data. The reference image formation unit 44 accepts image data from the development unit 43 and performs processing in imitation of the optical image by rounding the corner of the figure shape and gradating somewhat and forms the reference image.

(Pattern Inspection Method)

It can be deemed that FIG. 1 is a flow of processing example of a pattern inspection method. This pattern inspection method includes: forming a reference image from CAD data (for example, depiction data); acquiring a stream image from a reticle by the optical image acquisition unit; storing the stream image in the stream image memory device; performing DB comparison which compares a specific die of the stream image, defined as the reference die, by the DB comparison unit 52; performing DD comparison which compares the reference die with other die by the DD comparison unit 51; and analyzing different data found by the DB comparison and the DD comparison by the defect analysis unit 53. In this way, the pattern inspection of the reticle can be properly and correctly carried out by performing the DB comparison and the DD comparison.

(Inspection Sample Inspected)

The reticle 2, which is the inspection sample, is depicted by a depiction device using design data. The reticle 2 is performed by the pattern inspection using the pattern inspection apparatus 1. This pattern inspection is performed by DD comparison, by which the stream image 21 in the reticle 2 is stored in the stream image memory device 36 and each of the dies 22 of the stream image 21 is mutually compared. Provision of a plurality of the stream image memory devices 36 allows parallelly performing the DD comparison and efficiently performing the pattern inspection.

### First Embodiment

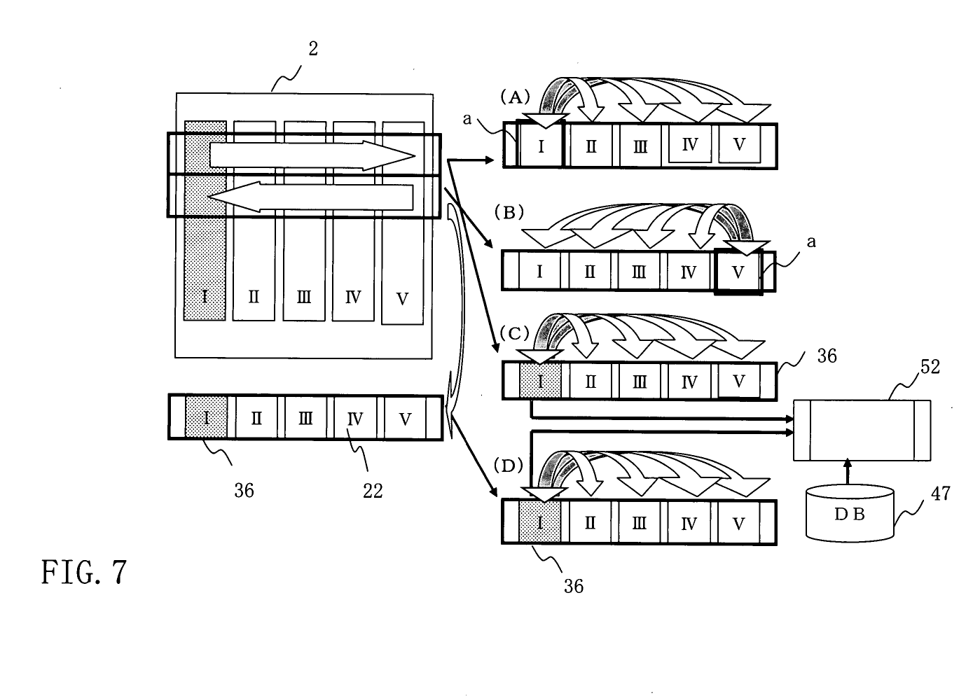

FIG. 7 shows pattern inspection examples (A and B), each storing only one die, and a first embodiment (C and D) of the present invention. Comparison methods of (A) and (B) in FIG. 7 are a reference die method using a memory device in which only one die stores. Therefore, image marked by “a” of only a die I is stored, which is defined as a reference die 23, in the direction scanned toward the right side, and DD comparison is performed, comparing it with dies II to V scanned following the die I. Next, image marked by “a” of only a die V is stored, which is defined as a reference die 23, in the reverse direction scanned toward the left side at a second column, and DD comparison is performed, comparing it with dies IV to I scanned following the die V. In this way, the die defined as the reference is located at the left side (die I) or at the right side (die V), which is different depending on the scanning direction. The die I is located at the opposite side to and apart from the die V in the reticle. Therefore, it is more likely to be different in state of depicted pattern, thus it is not suitable for the die 22 to be defined as the reference to perform accurate pattern inspection.

On the other hand, a comparison method according to the first embodiment of the present invention shown with (C) and (D) in FIG. 7, the stream image 21 in the stream unit is buffered (die I to die V are simultaneously stored). Therefore, in the case of scanning in the right direction, the die I is also stored as shown with (C) in FIG. 7 and defined as the reference die 23. DD comparison can be performed, comparing the remaining dies II to V with this reference die (die I) 23. Next, in the case of scanning in the left direction, the stream image 21 is buffered (dies V to I are simultaneously stored) as shown with (D) in FIG. 7. The die I is also stored and defined as the reference die 23. DD comparison can be performed, comparing the remaining dies V to I with this reference die (die I) 23. In this way, the reference die 23 can be fixed at any location (for example, left side or right side) without depending on the stage movement direction (scanning direction). Therefore, each reference die 23 is placed at an analogous location, so that difference between the reference dies is small and variation in DD comparison processing with respect to each die is less likely to be occurred. Furthermore, defects of the reference die 23, obtained in the DB comparison processing by performing DB comparison processing of the reference die, can also be known. As described, only the reference die 23 is performed by the DB comparison processing and the remaining dies are performed by the DD comparison processing, comparing the reference die 23 with the remaining dies; therefore, the remaining dies can also obtain similar effects as in the DB comparison processing. Consequently, even when the DB comparison processing is not performed with respect to the entire dies, it is possible to accurately perform pattern inspection and to shorten inspection time.

### Second Embodiment

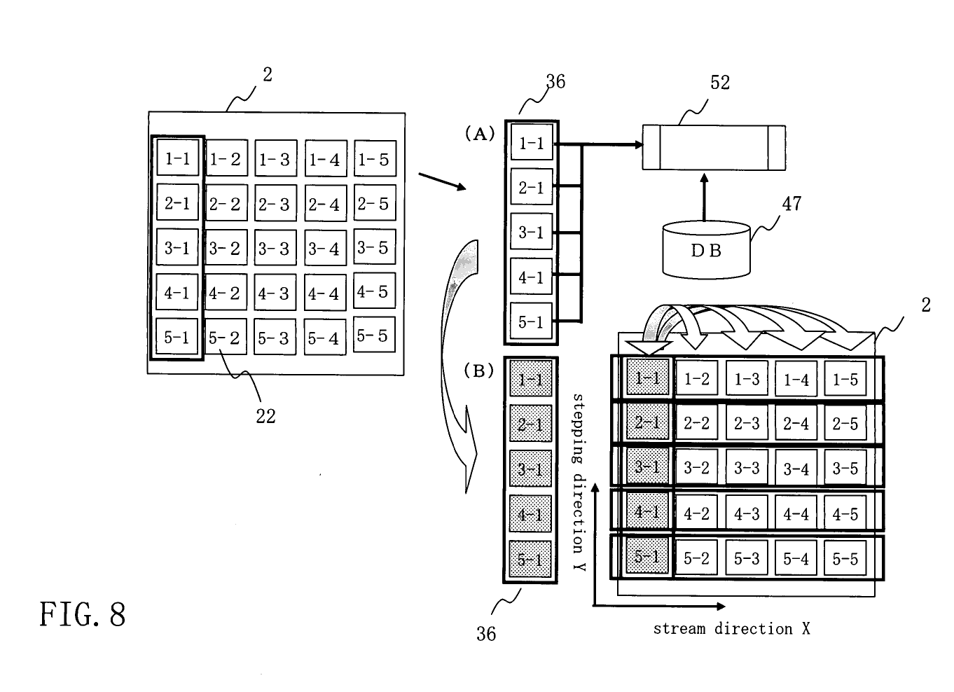

FIG. 8 shows a pattern inspection according to a second embodiment of the present invention. A comparison method of the second embodiment is a pattern inspection of a multiple die reticle of N(X)×M(Y) (N dies in the X direction and M dies in the Y direction). In this comparison method, first as shown in (A) in FIG. 8, a line (stepping direction) of dies in the Y direction of 1(X)×M(Y) are buffered and stored in a memory device for DB comparison processing 36 as a reference die 23. Those dies, die 1-1 to die 5-1, performed by DB comparison processing are defined as the reference dies. Next, dies (for example, die 1-2 to die 1-5) stored in the stream image memory device 36 are performed by DD comparison processing using the reference dies 23. In this way, high-sensitive inspection equivalent to DB comparison processing with respect to the entire dies can be performed, without performing DB comparison processing with respect to the entire dies being heavy load, by using buffered scanning images for the DD comparison processing of X direction (stream direction).

### Third Embodiment

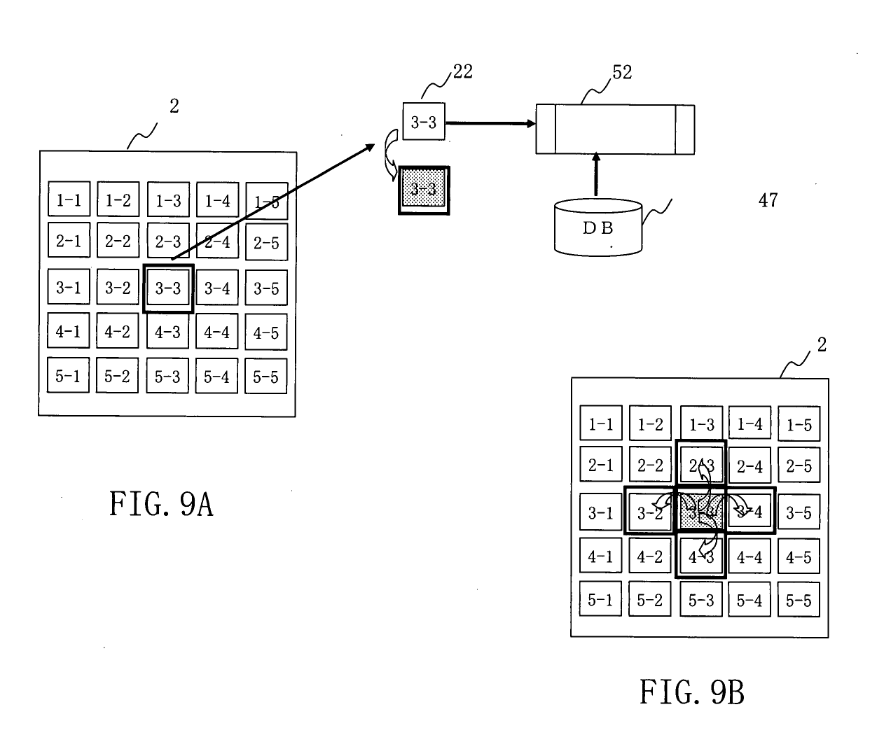

FIG. 9(A) and FIG. 9(B) show a pattern inspection according to a third embodiment of the present invention. A comparison method of the third embodiment is a pattern inspection of a multiple die reticle of N(X)×M(Y). In this comparison method, the center die that is stable in depiction accuracy is performed by DB comparison process, and scanned image is buffered, which is defined as a reference die. The remaining dies in the entire reticle are performed by DD comparison processing, comparing with the reference die. This allows shortening inspection time and increasing inspection accuracy at the same time.

### Other Embodiment

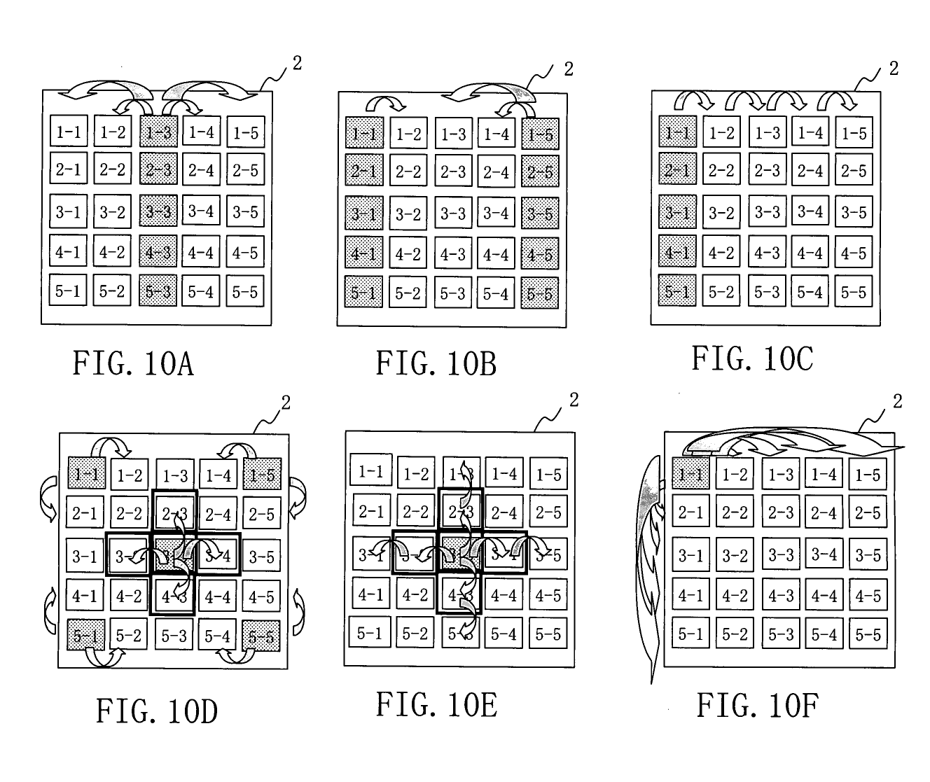

FIG. 10(A) to FIG. 10(F) show various kinds of pattern inspection methods according to embodiments of the present invention. Comparison methods of these embodiments are pattern inspections of a multiple die reticle of N(X)×M(Y). In the comparison method shown in FIG. 10(A), DB comparison processing is performed with respect to a line of dies in the vicinity of the center (for example, die 1-3 to die 5-3); scanned images are buffered and stored in the stream image memory device, which are defined as reference dies. DD comparison processing is performed with respect to dies in each X direction using these reference dies. This allows shortening inspection time and increasing inspection accuracy at the same time.

In the comparison method shown in FIG. 10(B), DB comparison processing is performed with respect to two lines of dies in the vicinity of the right and left sides (for example, die 1-1 to die 5-1 and die 1-5 to die 5-5); scanned images are buffered and these are defined as reference dies. DD comparison processing is performed with respect to dies in each X direction using these reference dies. In this case, since there are many reference dies, it is possible to further shorten inspection time when parallel processing is performed and to increase inspection accuracy at the same time.

In the comparison method shown in FIG. 10(C), DB comparison processing is performed with respect to a line of dies in the vicinity of the left side (for example, die 1-1 to die 5-1); scanned images are buffered and these are defined as reference dies. DD comparison processing is performed with respect to adjacent dies in each X direction (for example, die 1-2 to die 5-2) using these reference dies. DD comparison processing is performed, comparing the dies (for example, die 1-2 to die 5-2) with their adjacent dies (for example, die 1-3 to die 5-3). Further, DD comparison processing is performed, comparing the dies (for example, die 1-3 to die 5-3) with their adjacent dies (for example, die 1-4 to die 5-4). In this way, adjacent dies are performed by DD comparison processing, and therefore it is possible to further shorten inspection time and to increase inspection accuracy at the same time.

In the comparison method shown in FIG. 10(D), DB comparison processing is performed with respect to dies in the vicinity of the center and four corners (for example, die 1-1, die 1-5, die 5-1, and die 5-5) and these are defined as the reference dies. DD comparison processing is performed with respect to adjacent dies using these reference dies. Further, DD comparison processing is performed, comparing adjacent die with its adjacent reference die. Alternatively, adjacent dies may be performed by DD comparison processing. In this way, it is possible to shorten inspection time and to increase inspection accuracy at the same time.

In the comparison method shown in FIG. 10(E), DB comparison processing is performed with respect to a die in the vicinity of the center (for example, die 3-3) and this is defined as the reference die. DD comparison processing is performed with respect to adjacent dies using the reference die. Further, with respect to the adjacent dies, DD comparison processing is performed, comparing with the adjacent dies. In this way, it is possible to shorten inspection time and to increase inspection accuracy at the same time.

In the comparison method shown in FIG. 10(F), DB comparison processing is performed with respect to a die in the vicinity of one of the corners (for example, die 1-1) and this is defined as the reference die; and the remaining dies are performed by DD comparison processing, being compared with the reference die. Further, adjacent dies may be performed by DD comparison processing. In this way, it is possible to shorten inspection time and to increase inspection accuracy at the same time.

It is needless to say that the present invention is not limited to the embodiments described hereinbefore.

What is claimed is:

1. A pattern inspection apparatus for inspecting a pattern of a plurality of dies formed in an inspection sample, comprising:
a stream image memory device which stores a stream image of the inspection sample; and
a DD comparison unit which performs DD comparison, mutually comparing the pattern of each of the dies in the stream image.

2. The pattern inspection apparatus according to claim 1, comprising:
a plurality of the stream image memory devices capable of storing a plurality of the stream images.

3. The pattern inspection apparatus according to claim 1, comprising:
a plurality of the stream image memory devices capable of storing a plurality of the stream images; and
a plurality of the DD comparison units which parallelly process the plurality of the stream images.

4. The pattern inspection apparatus according to claim 1, comprising:
a DB comparison unit which performs DB comparison, comparing a die at a specific position of the stream image; and
a DD comparison unit which performs DD comparison, with which the die at the specific position performed by the DB comparison, defined as a reference die, is compared with other die.

5. The pattern inspection apparatus according to claim 1, comprising:
a DB comparison unit which performs DB comparison, comparing a die at a specific position, which is each stream image of the plurality of stream images; and
a DD comparison unit which performs DD comparison, with which the die at the specific position, which is the each stream image, performed by the DB comparison, defined as a reference die, is compared with other die.

6. The pattern inspection apparatus according to claim 1, comprising:
a memory device for DB comparison which stores a reference die.

7. The pattern inspection apparatus according to claim 1, wherein the inspection sample includes N dies in the X direction and M dies in the Y direction, the pattern inspection apparatus comprising:
a DB comparison unit which performs DB comparison, comparing a die at any position; and
a DD comparison unit which performs DD comparison, with which the die performed by the DB comparison, defined as a reference die, is compared with other die.

8. The pattern inspection apparatus according to claim 1, wherein
the inspection sample includes N dies in the X direction and M dies in the Y direction, the pattern inspection apparatus comprising:
a DB comparison unit which performs DB comparison, comparing M dies at a certain position from an end; and
a DD comparison unit which performs DD comparison, with which the M dies performed by the DB comparison, defined as reference dies, are compared with N-1 dies in the X direction of the stream image to which the reference dies belong.

9. The pattern inspection apparatus according to claim 1, wherein the inspection sample includes N dies in the X direction and M dies in the Y direction, the pattern inspection apparatus comprising:
a DB comparison unit which performs DB comparison, comparing M dies at a predetermined position from an end; and
a DD comparison unit which performs DD comparison, with which the M dies performed by the DB comparison, defined as reference dies, are compared between adjacent dies of the stream image to which the reference dies belong.

10. The pattern inspection apparatus according to claim 1, wherein the inspection sample includes N dies in the X direction and M dies in the Y direction, the pattern inspection apparatus comprising:
a plurality of stream image memory devices capable of storing a plurality of stream images;
a DB comparison unit which performs DB comparison, comparing a specific die of the each stream image; and
a plurality of DD comparison units which parallelly perform DD comparison, with which the specific die performed by the DB comparison, defined as a reference die, is compared with respect to N-1 dies in the X direction of the stream image to which the reference die belong.

11. A pattern inspection method for inspecting a pattern of a plurality of dies formed in an inspection sample, comprising:
storing a stream image of the inspection sample in a memory device; and
performing DD comparison processing which performs DD comparison, mutually comparing each of the dies.

12. The pattern inspection method according to claim 11, comprising:
storing a plurality of the stream images in the memory device.

13. The pattern inspection method according to claim 11, wherein the inspection sample includes N dies in the X direction and M dies in the Y direction, the pattern inspection method comprising:
performing DB comparison processing which performs DB comparison, comparing a die at any position; and
performing DD comparison processing which performs DD comparison, comparing the die performed by the DB comparison, defined as a reference die, with other die.

14. The pattern inspection method according to claim 11, wherein
the inspection sample includes N dies in the X direction and M dies in the Y direction, the pattern inspection method comprising:
storing a plurality of the stream images and performing a DB comparison, comparing a specific die of the each stream image; and
performing DD comparison processing which parallelly performs DD comparison, comparing the specific die performed by the DB comparison, defined as a reference die, with respect to N-1 dies in the X direction of the each stream image to which the reference die belongs.

15. An inspection sample having patterns of a plurality of dies, wherein
a stream image of the inspection sample is stored and DD comparison is performed, mutually comparing each of the dies.
